(19) United States
(12) Patent Application Publication
(10) Pub. No.: US 2010/0170739 A1
(43) Pub. Date: Jul. 8, 2010

(54) CHASSIS

(75) Inventor: Andrew North, Oxford (GB)

Correspondence Address: SCULLY SCOTT MURPHY & PRESSER, PC, 400 GARDEN CITY PLAZA, SUITE 300, GARDEN CITY, NY, 11530, US

(73) Assignee: BAE SYSTEMS PLC, London (GB)

(21) Appl. No.: 12/300,716

(22) PCT Filed: Sep. 3, 2008
(86) PCT No.: PCT/GB2008/050774

§ 371 Date: Nov. 13, 2008

(30) Foreign Application Priority Data
Sep. 11, 2007 (EP) 07253599.0
Sep. 11, 2007 (GB) 0717712.4

(51) Int. Cl. B62D 21/02

(52) U.S. Cl. 180/312; 280/800

(57) ABSTRACT

There is disclosed a chassis for a high mobility vehicle, the vehicle defining a longitudinal axis, the chassis comprising a tubular transmission member generally parallel to the longitudinal axis and extending from a foremost axle to a rearmost axle and thus defining a transmission axis at least one structural member the tubular transmission member being connected to the at least one structural member wherein the chassis comprises at least one foremost attachment means whereby recovery means may attach to the chassis, the attachment means being arranged with one of the structural members such that recovery loads are transmitted through the said one of the structural members.

The following invention relates to a chassis for a high mobility vehicle (hmv), and in particular to such a chassis comprising a tubular transmission member and reinforced to withstand a recovery force.

Multi-axle, high mobility vehicles such as the ‘Pinzgauer 718’ are known having a tubular transmission member running the length of the chassis undercarriage between the foremost and rearmost axle. This tubular transmission member (ttm) acts as a load bearing structure and also locates features of the drive train.

Tubular transmission members tend to be more rigid than surrounding components of the vehicle. Consequently, forces experienced by areas of the chassis other than the tubular transmission member are generally transferred to the tubular transmission member.

Typically, the tubular transmission member is attached to the cab of the vehicle by simple attachment means such as nuts and bolts. In circumstances where such known high mobililty vehicles become undesirably anchored (for example if the wheels have lost traction as a result of having gotten stuck in mud/quicksand), it is standard practice to attach a cable to a section of the cab and apply a tension to the cable. The vehicle is thus pulled out of its anchored position (which in this example is the mud) by way of a recovery force.

However, such a manoeuvre puts a considerable stress on the bolts connecting the cab to the tubular transmission member. This stress can weaken the connection between the cab and the tubular transmission member by causing the propagation of cracks. In extreme cases the stress may be so great as to exceed the ultimate tensile stress of the bolt material. In such extreme cases, the cab will break off the tubular transmission member.

It is therefore an object of the present invention to provide a chassis structure for a high-mobility vehicle that mitigates the aforementioned problems.

In broad terms the invention resides in the concept of reinforcing a tubular transmission member such that a chassis is better able to withstand a recovery load.

Accordingly, there is provided a chassis for a high mobility vehicle, the vehicle defining a longitudinal axis, the chassis comprising:
a tubular transmission member generally parallel to the longitudinal axis and extending from a foremost axle to a rearmost axle and thus defining a transmission axis
   at least one structural member
   the tubular transmission member being connected to the at least one structural member
   wherein the chassis comprises at least one foremost attachment means whereby recovery means may attach to the chassis, the attachment means being arranged with one of the structural members such that recovery loads are transmitted through the said one of the structural members.

Advantageously this provides a stronger chassis because the additional structural members alleviate the stress on other components.

Preferably the at least one structural members have a generally C-shaped cross section and are arranged such that the open part of the members face away from each other.

This gives rise to the advantage that other components of the vehicle, such as air suspension modules, can easily be fixed onto the structural members by arranging mounts within the section. This reduces build time and makes repair simpler.

Preferably the at least on structural member is connected to a plate member, the plate member attaching to the foremost end of the at least one structural member.

This beneficially acts to both reinforce the connections between the two structural elements and also forms a foundation for a vehicle cab. By fulfilling both of these roles with one component, the chassis minimises weight and reduces build time.

Preferably the plate member comprises a trough section.

This beneficial feature of the chassis serves two purposes. Firstly, it forms an internal space which can be used as a footwell in the vehicle cab. Secondly, it forms a space which can be occupied by a further structural feature, for example a generally longitudinal wall or panel, communicating between the structural members and the foremost parts of the vehicle.

Preferably the plate member further comprises a hood.

Advantageously, this can be used to locate an engine radiator.

Preferably the hood comprises a panel generally aligned with the at least one structural member.

Advantageously, such panels act to transfer recovery stress from parts of the vehicle to the fore (where recovery loads are applied) to the structural members to the rear. The use of such panels to locate the radiator makes efficient use of material thereby tending to reduce overall weight and simplify construction.

Preferably the plate member comprises a mount to which a bumper may attach, the mount being aligned with the at least one structural member and the panel.

This provision gives a consolidated rigid structure which is generally straight. Such a structure is particularly suited to sharing loads (for example the tensile stress appropriated from a recovery force) about the parts of the chassis connected to the transmission member.

Preferably the attachment means comprises a shackle, mounted on the bumper, for locating recovery means, wherein the shackle is aligned with the at least one structural member.

This maintains the generally linear force path established along the length of the chassis by the alignment of the more rigid components of the chassis. The shackle specifically locates the recovery force at a point generally in alignment with this linear path. In general the recovery force will be applied along the axis of the linear path formed by the more rigid components of the chassis. This therefore minimises the moment arm and so reduces bending moments and associated shear stress.

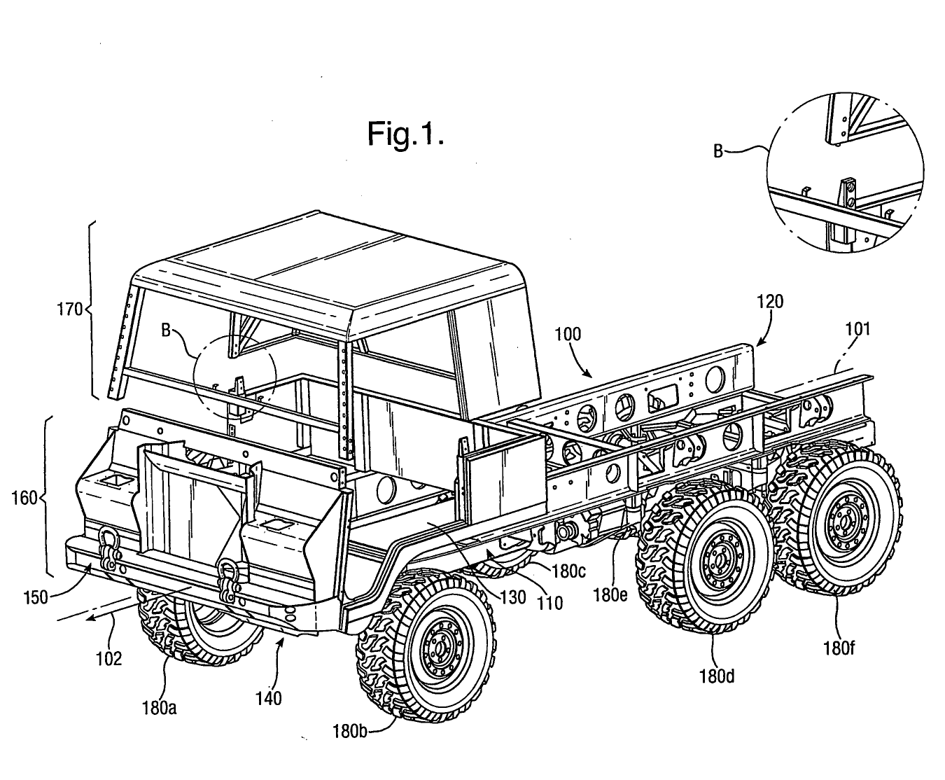

FIG. 1 shows a geometric view of the arrangement of a chassis, wheels, and exploded cab in a three-axle drive HMV.

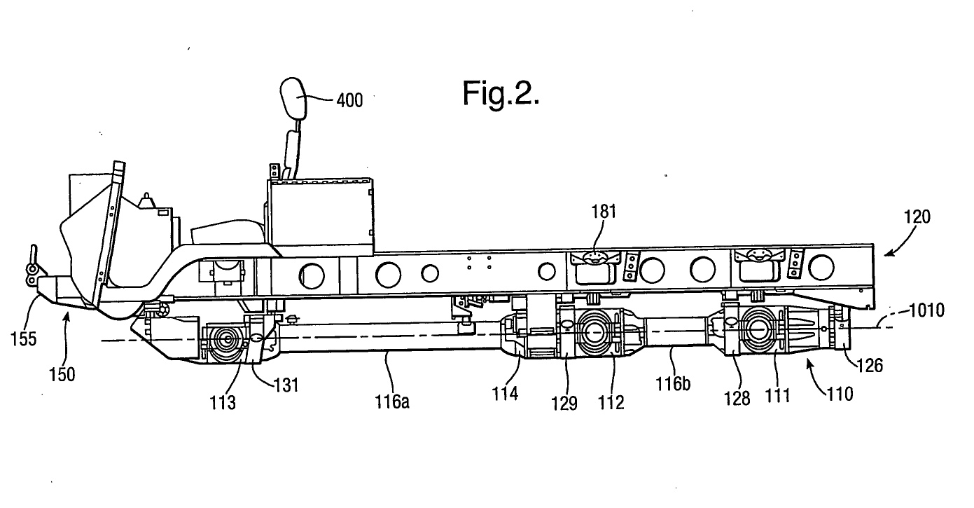

FIG. 2 shows a side view of a chassis of a three-axle drive HMV

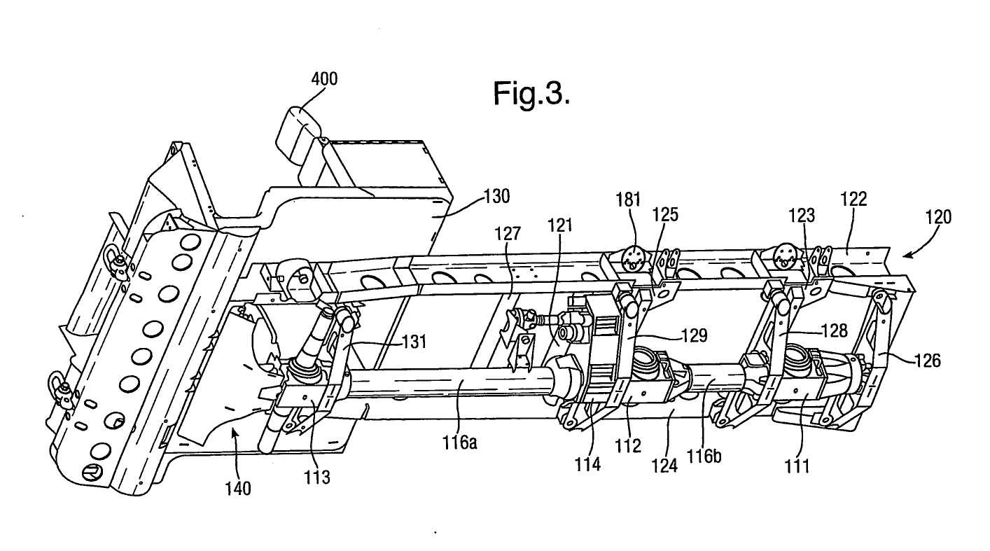

FIG. 3 shows a geometric view from below of the three-axle drive HMV chassis.

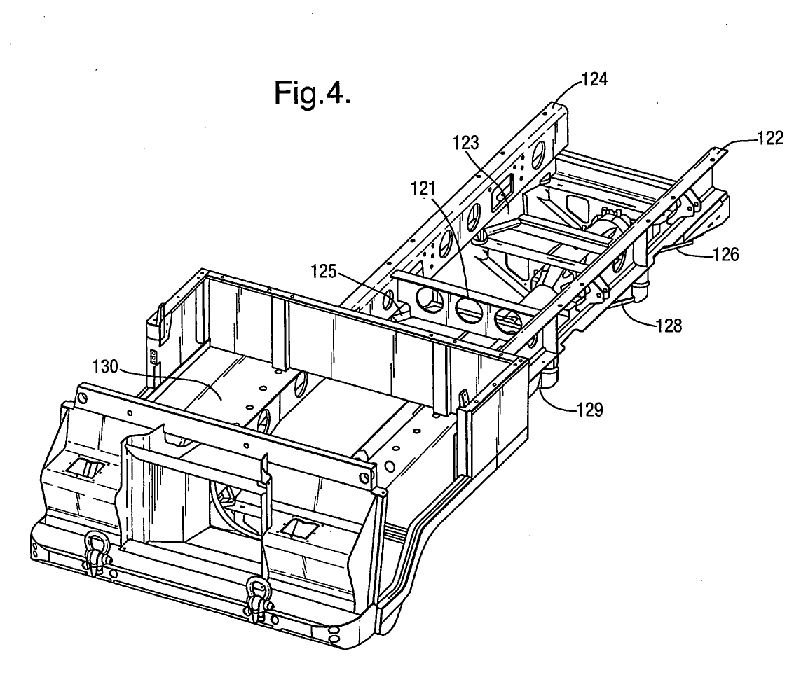

FIG. 4 shows a geometric view from above of the three-axle drive HMV chassis.

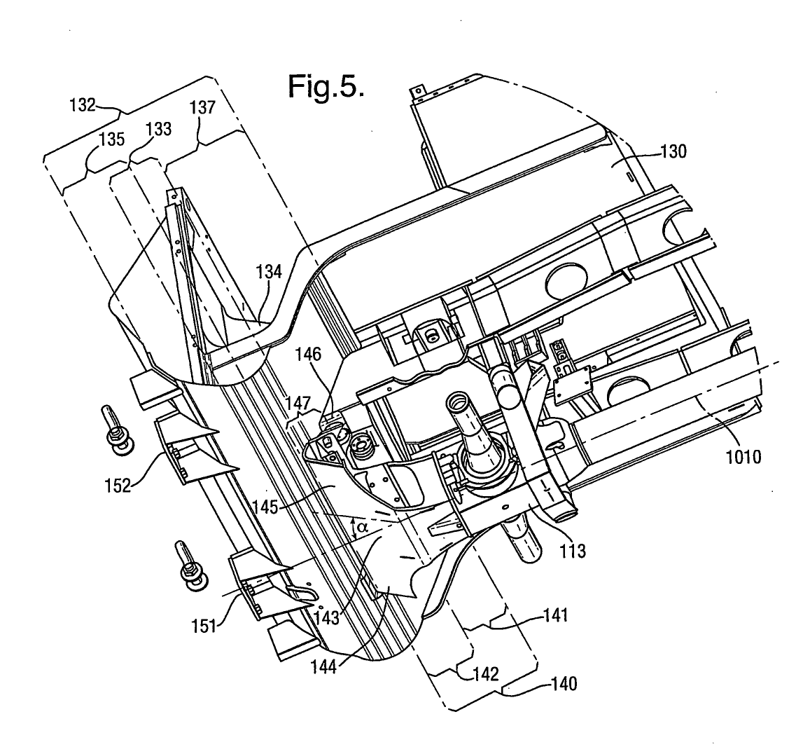

FIG. 5 shows a close up geometric view of the foremost undercarriage of the three-axle drive HMV chassis, wheels have been removed for ease of viewing.

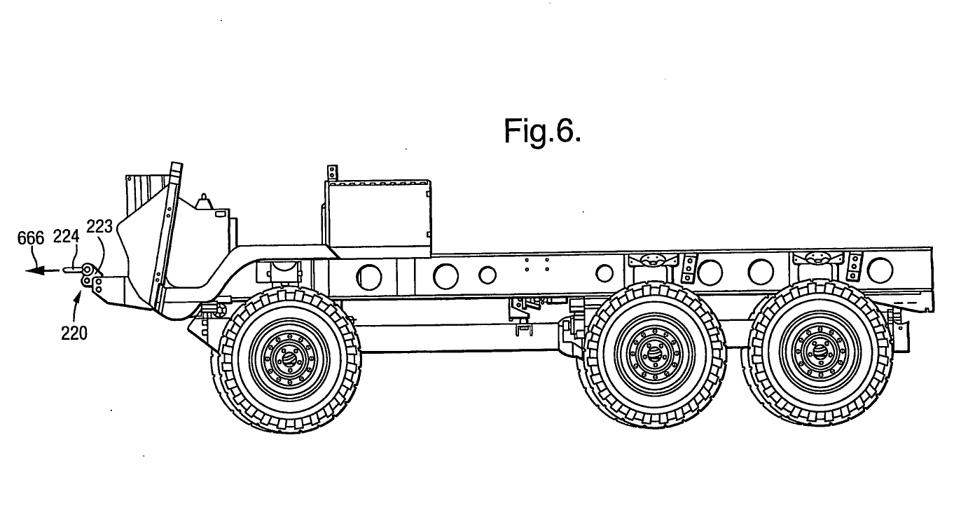

FIG. 6 shows a side view of how a recovery force may be applied to the three-axle drive HMV chassis at an attachment means.

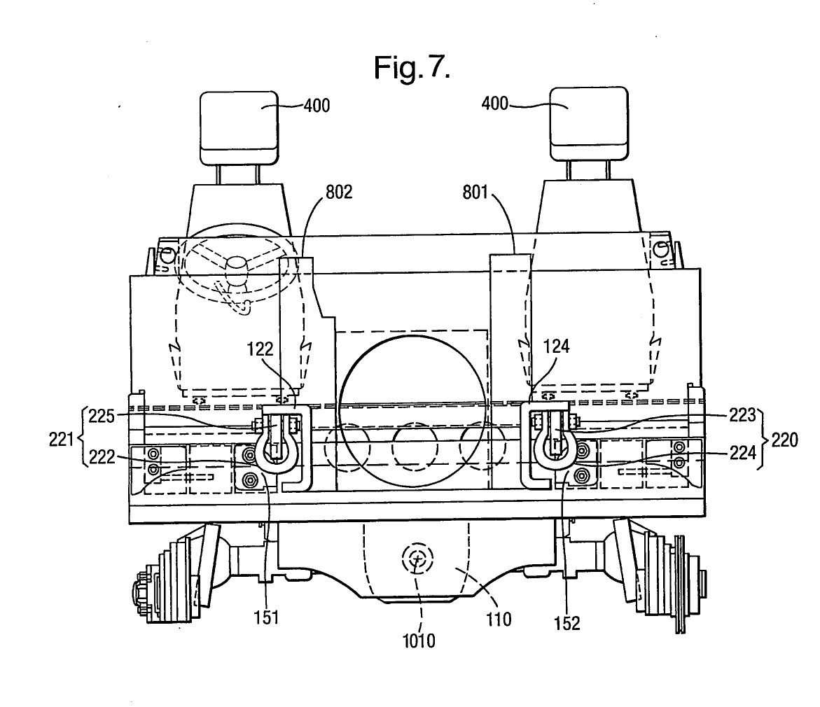

FIG. 7 shows a front on view of the chassis with dotted lines representing hidden components. Thicker outlines and shading have been used where necessary to highlight longitudinally aligned components which comprise the force path.

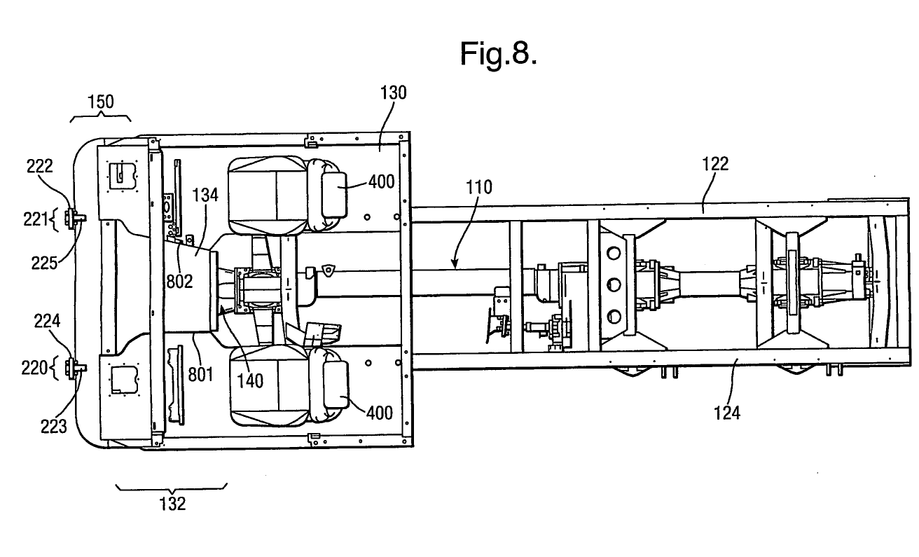

FIG. 8 shows the chassis viewed from above and in a direction normal to the longitudinal/lateral plane.

Reference is made throughout the specification to a HMV, this is to be understood to mean any vehicle which is particularly suited to driving on a wide range of terrains. Such a range should encompass steeply inclined surfaces, rough surfaces (such where boulders may be encountered) and waterlogged surfaces (which may tend to anchor vehicles).

Referring primarily to FIG. 1, in the three-axle drive HMV of the present embodiment, a chassis (generally indicated at 100) comprises a tubular transmission member 110, a ladder structure 120, a rigid plate member 130, a hammer head plate 140 and a bumper 150. Rigid plate member 130 is part of a lower cab structure 160 which has an upper interface surface for engaging the lower interface surface of an upper cab 170. In FIG. 1, six wheels 180a-f are arranged in pairs on axles making up the transmission. The foremost wheels, 180a and 180b are fixed on the foremost axle. The rearmost wheels 180e and 180f are fixed on the rearmost axle. The vehicle is three-axle drive, alternatively referred to as six wheel drive.

It can be appreciated that the vehicle incorporating the chassis 100 defines a longitudinal axis 101. As the vehicle moves forwards (or backwards) in a straight line 102, it travels along this longitudinal axis 101.

Referring primarily to FIGS. 2 and 3 the arrangement of the tubular transmission member 110 is further explained. Tubular transmission member 110 acts to improve chassis rigidity. Tubular transmission member 110 comprises rigid tubing 116a, b which not only shields dynamic components of the transmission from dirt but also acts as a load bearing member as the chassis experiences operational loads.

A foremost axle differential gear casing 113 is attached to the foremost end of the rigid tube 116a. The rearmost end of the rigid tube 116a is in turn attached to the drive gear casing 114. Drive gear casing 114 is connected to an intermediate axle differential gear casing 112. Differential gear casing 112 is attached to a second section of rigid tube 116b which in turn connects to the rearmost axle differential gear casing 111. The tubular transmission member is made up of the casings 111,112,113,114 and the rigid tubing 116a,b. Rigid tubes 116a,b are generally cylindrical and thereby define the axis 1010 of the tubular transmission member 110.

Seats 400, for accommodating a person, are shown to give an indication of the scale of the described embodiment.

Referring primarily to FIG. 3 and FIG. 4, ladder structure 120 comprises a first structural member 122 and a second structural member 124. These members 122 and 124 run generally parallel to one another and the longitudinal axis 101. Each member 122, 124 defines a member axis, each member axis is displaced from the TTM axis 1010 by the same distance. The first structural member 122 and the second structural member 124 are both connected at an uppermost surface of their foremost ends to rigid plate 130. Hence the foremost ends of the structural members 122,124 are fixedly located. Other sections of the structural members are connected to one another by means of an ‘S’-sectioned brace 121, webbed brace members 123 and 125, and brace 127.

Ladder structure 120 is connected to tubular transmission member 110 by joists 126, 128, 129 and 131. Each joist has a central section to which transmission casings 111,112,113,114 can be bolted and also arm sections, one of which extends to attach to structural member 122 and the other of which extends to attach to structural member 124. The joists fix the transmission member below the ladder structure.

Each structural member 122, 124 has a C-shaped cross section. In the present embodiment, structural members 122 and 124 have three wall sections, the first and second of which are generally parallel, the third being perpendicular to the two and extending between an end region of the first to an end region of the second thus forming the generally C-shaped cross-section. There is a fillet at the join between wall sections. The structural members 122, 124 are arranged relative to each other so that the open aspects of the C-shaped cross section face away from each other. Having the members 112 and 124 arranged like this allows further components of the vehicle, such as the air suspension units, to fit neatly into the ladder member 120 (on platforms such as 181) thus saving space.

Referring primarily to FIG. 5, the arrangement of the foremost section of the chassis is explained. Hammer head plate 140 comprises a neck section 141, attaching at a first end to the foremost end of casing 113, and a wedge section 142 extending forward from the second end of the neck section 141 and flaring out to form a head member 147 with an axis normal to the tubular transmission member axis. Wedge section 142 comprises a first prominent undercarriage surface 143. The surface 143 is inclined to the TTM axis 1010 by angle a and extends from a minimum ground clearance at its rearmost end to a maximum ground clearance at its foremost end. Such an arrangement results in the hammer head 140, and in particular the first prominent undercarriage surface 143, being the prominent member of the undercarriage as the vehicle is approaches obstacles having a height approximately equal to the clearance of the hammer head plate 140.

Sides 145 and 144 of hammer head plate 140 are attached by means of components 146 to the structural members 122 and 124 respectively.

Plate member 130 has two generally flat sections, one attaching to the uppermost side of the structural member 122, and the other attaching to the uppermost side of the structural member 124. These flat sections (and hence the structural members 122, 124) are joined together along their rearmost end by wall 138. Plate member 130 also has a trough section 132 which, following the plate member 130 forwards from the foremost end of the flat section, dips downwards to form a surface 137 covering the foremost end of the structural members 122, 124. The structural members 122 and 124 meet the trough section 132. The lowest point of this trough 132 effectively forms a member 133 along an axis normal to the tubular transmission member axis. The member 133 is located in a space between the structural member axes and the tubular transmission member axis 1010. Member 133 has a second prominent undercarriage surface 135 which is inclined to the transmission member axis 1010 so as to extend from a minimum clearance at its rearmost end to a maximum clearance at its foremost end. Such an arrangement results in member 133, and in particular second prominent undercarriage surface 135, being the most prominent member of the undercarriage as the vehicle approaches obstacles with a height approximately equal to the clearance of the member 133.

Referring also to FIG. 2, forward of the trough section 132 is bumper 150 (not shown in FIG. 5). The bumper 150 is located in front of the trough section 132 and is attached to mounts 152 and 151 which extend forwardly out of the trough section 132. The foremost edge of the bumper 150 has a third prominent undercarriage surface 155. Surface 155 is inclined to the tubular transmission member axis 1010 so as to extend from a minimum clearance at its rearmost end to a maximum clearance at its foremost end.

Referring additionally to FIG. 8, plate member 130 also comprises a rigid hood 134 which is attached to trough section 132. The hood 134 comprises two generally vertical panels 801, 802 that are generally parallel with the ttm axis (the panels laterally diverge towards the foremost end). As can be seen from FIG. 7, one vertical panel 802 tends towards alignment with structural member 122 and the other 801 tends towards alignment with structural member 124. Both extend upwardly from trough section 132. The top of the vertical panels 801, 802 are joined by a third panel.

Two attachment means 220, 221 are provided on the bumper 150 for attachment with a recovery cable. Each attachment means 220, 221 comprises a shackle mount 223, 225 that links a shackle 224, 222. Attachment means 220 is generally in alignment with structural member 124, a vertical panel 801 of the hood 134, and mount 152 (as can be seen from FIGS. 6, 8 and 7). Attachment means 221 is generally in alignment with structural member 122, second vertical panel 802 of the hood 134, and mount 151 (as can be seen from FIGS. 6, 8 and 7).

The shackles 224, 222 locate the recovery force 666. The recovery force 666 will in the majority of cases be applied in a generally longitudinal direction. Therefore, since the attachment means 220, the mount 152, the hood panels 801 and the structural member 124 are in longitudinal alignment (and likewise 221, 151, 801 and 124) bending moments will be minimised. Furthermore, because the tension will be at least partly transferred along the structural members 122, 124, the concentration of stress in the foremost axle will be reduced.

The structural members 122 and 124 are made from high strength steel to maintain the chassis rigidity established by the TTM.

The Plate member 130 is made from high strength steel sheeting having a depth of approximately 6 mm. The structural members 122, 124 are fixedly attached to the plate member 130 by way of a puddle welding process.

Other aspects of the described HMV can be fabricated from materials and components known to the skilled man.

A wide range of variants of the described invention would be apparent to the skilled man as being within the scope of the invention.

The HMV may, for example, be a four wheel drive vehicle (i.e. two axle drive), particularly if the vehicle is not required to carry such a great load as is the six wheel drive vehicle.

1. A chassis for a high mobility vehicle, the vehicle defining a longitudinal axis, the chassis comprising:
a tubular transmission member generally parallel to the longitudinal axis and extending from a foremost axle to a rearmost axle and thus defining a transmission axis
at least one structural member
the tubular transmission member being connected to the at least one structural member
wherein the chassis comprises at least one foremost attachment means whereby recovery means may attach to the chassis, the attachment means being arranged with one of the structural members such that recovery loads are transmitted through the said one of the structural members.

2. A chassis according to claim 1 wherein each of the at least one structural members have a generally C-shaped cross section and are arranged such that the open part of the members face away from each other.

3. A chassis according to claim 1 wherein the at least one structural member is connected to a plate member, the plate member attaching to the foremost end of the at least one structural member.

4. A chassis according to claim 3 wherein the plate member comprises a trough section.

5. A chassis according to claim 3 wherein the plate member further comprises a hood.

6. A chassis according to claim 5 wherein the hood comprises a panel generally aligned with the at least one structural member.

7. A chassis according to claim 6 wherein the plate member comprises a mount to which a bumper may attach, the mount being aligned with the at least one structural member and the panel.

8. A chassis according to claim 7 wherein the attachment means comprises a shackle, mounted on the bumper, for locating recovery means, wherein the shackle is aligned with the at least one structural member.
